(19) United States
(12) Patent Application Publication
(10) Pub. No.: US 2023/0115735 A1
(43) Pub. Date: Apr. 13, 2023

(54) ANTENNA DIRECTION ADJUSTING METHOD, PORTABLE STATION DEVICE AND ANTENNA DIRECTION ADJUSTING PROGRAM IN SATELLITE COMMUNICATION SYSTEM

(71) Applicant: NIPPON TELEGRAPH AND TELEPHONE CORPORATION, Tokyo (JP)

(72) Inventors: Koichi HARADA, Musashino-shi, Tokyo (JP); Masaki SHIMA, Musashino-shi, Tokyo (JP); Hiroki SHIBAYAMA, Musashino-shi, Tokyo (JP); Fumihiro YAMASHITA, Musashino-shi, Tokyo (JP)

(73) Assignee: NIPPON TELEGRAPH AND TELEPHONE CORPORATION, Tokyo (JP)

(21) Appl. No.: 17/914,917

(22) PCT Filed: Mar. 30, 2020
(86) PCT No.: PCT/JP2020/014705

§ 371 Date: Sep. 27, 2022

(51) Int. Cl. H04B 7/155

(52) U.S. Cl. CPC H04B 7/155

(57) ABSTRACT

A portable station stores satellite information related to the longitude and the beacon signal of a plurality of communications satellites, executes a rough adjustment process of computing an antenna direction with respect to a target communications satellite on the basis of the longitude of the target communications satellite acquired from the satellite information and an installation location of the portable station itself, and roughly adjusting the antenna direction of the portable station itself in the computed antenna direction, and executes a fine adjustment process of, in a case where the frequency of a beacon signal is a predetermined frequency of the target communications satellite, measuring the beacon signal while increasing or decreasing the azimuth by treating the azimuth of the roughly adjusted antenna as a reference direction, and in a case where a measurement result of a beacon signal matches the information related to the beacon signal from another communications satellite at the longitude that is stored in the satellite information, aligning the azimuth of the antenna with the reference direction and finely adjusting the antenna direction such that the receive level of the beacon signal is maximized. With this arrangement, the antenna direction can be adjusted correctly using only the beacon signal.

### TECHNICAL FIELD

The present invention relates to technology for adjusting the antenna direction when a portable ground station initially connects to a communications satellite in a satellite communication system in a situation where communication with a satellite telecommunications carrier is unavailable due to an event such as a large-scale disaster.

### BACKGROUND ART

A very-small-aperture terminal (VSAT) system is known as satellite communication system provided with a portable ground station. A VSAT system uses a small, portable VSAT ground station provided with an antenna having a very small aperture to enable communication from locations where a communications satellite can be acquired, and consequently is utilized to secure communication during a disaster or the like. However, in the case of installing a portable ground station (referred to as a portable station), when putting the portable station into operation, it is necessary to adjust the antenna direction with respect to a target communications satellite. The antenna direction is adjusted by, for example, adjusting to an antenna direction obtained by calculation on the basis of the latitude and longitude of the station itself and information (longitude) about a target communications satellite acquired from the Global Positioning System (GPS) or the like, and then adjusting the antenna in the three directions of the azimuth, the elevation, and the polarization angle such that a beacon signal transmitted from the communications satellite reaches a maximum level (for example, see Patent Literature 1). Additionally, after adjusting the antenna direction, the portable station receives a control signal transmitted by a base station to check the synchronization, finally specifies the target communications satellite, and ends the process of initiating operations.

### CITATION LIST

### Patent Literature

Patent Literature 1: Japanese Patent No. 5592983

### SUMMARY OF THE INVENTION

### Technical Problem

However, in the case where the control signal from the base station is unavailable due to an event such as a large-scale disaster, if the antenna direction is adjusted using only the beacon signal from the communications satellite, and if a plurality of communications satellites have overlapping beacon frequencies, the portable station will be unable to specify whether or not a satellite is the target communications satellite, and there is a possibility that the portable station will mistakenly acquire another communications satellite transmitting the same beacon signal. For this reason, in the case of adjusting the antenna direction using only the beacon signal in the event of a large-scale disaster or the like, it is necessary to have a method that adjusts the antenna direction correctly and acquires the target communications satellite even if there is a plurality of communications satellites with overlapping beacon frequencies.

For antenna direction adjustment based on a beacon signal, an objective of the present invention is to provide an antenna direction adjustment method for a satellite communication system, a portable station, and an antenna direction adjustment program capable of adjusting the antenna direction correctly using only a beacon signal, even in the case where a control signal from a base station is unavailable due to an event such as a large-scale disaster.

### Means for Solving the Problem

One aspect of the present invention is an antenna direction adjustment method for a satellite communication system provided with a portable station, wherein the portable station stores satellite information related to a longitude and a beacon signal of a plurality of communications satellites, executes a rough adjustment process of computing an antenna direction with respect to a target communications satellite on a basis of the longitude of the target communications satellite acquired from the satellite information and an installation location of the portable station itself, and roughly adjusting the antenna direction of the portable station itself in the computed antenna direction, and executes a fine adjustment process of, in a case where a frequency of a beacon signal received from a satellite is a predetermined frequency of the target communications satellite, measuring the beacon signal while increasing or decreasing the azimuth by treating the azimuth of the roughly adjusted antenna as a reference direction, and in a case where a measurement result of a beacon signal from another communications satellite at a longitude corresponding to each azimuth matches the information related to the beacon signal from the other communications satellite at the longitude that is stored in the satellite information, aligning the azimuth of the antenna with the reference direction and finely adjusting the antenna direction such that a receive level of the received beacon signal is maximized.

Another aspect of the present invention is a portable station used in a satellite communication system, the portable station comprising a storage unit that stores satellite information related to a longitude and a beacon signal of a plurality of communications satellites, a measurement unit that receives a beacon signal from a communications satellite and measures a frequency at each polarization, and a control unit that executes a rough adjustment process of computing an antenna direction with respect to a target communications satellite on a basis of the longitude of the target communications satellite acquired from the satellite information and an installation location of the portable station itself, and controlling an antenna direction driving unit to roughly adjust the antenna direction of the portable station itself in the computed antenna direction, and executes a fine adjustment process of, in a case where a frequency for each polarization of a beacon signal measured by the measurement unit is a predetermined frequency of the target communications satellite, performing the measurement while increasing or decreasing the azimuth by treating the azimuth of the roughly adjusted antenna as a reference direction, and in a case where a measurement result of a beacon signal from another communications satellite at a longitude corresponding to each azimuth matches the information related to the beacon signal from the other communications satellite at the longitude that is stored in the satellite information, aligning the azimuth of the antenna with the reference direction and finely adjusting the antenna direction such that a receive level of the received beacon signal is maximized.

Also, an antenna direction adjustment program according to the present invention causes a computer to execute a process executed according to the antenna direction adjustment method.

### Effects of the Invention

For antenna direction adjustment based on a beacon signal, the antenna direction adjustment method for a satellite communication system, the portable station, and the antenna direction adjustment program according to the present invention are capable of adjusting the antenna direction correctly using only a beacon signal, even in the case where a control signal from a base station is unavailable due to an event such as a large-scale disaster.

### BRIEF DESCRIPTION OF DRAWINGS

FIG. 1 is a diagram illustrating an example of a satellite communication system according to an embodiment.

FIG. 2 is a diagram illustrating an example of an ordinary satellite communication system.

FIG. 3 is a diagram illustrating an example arrangement of a plurality of communications satellites.

FIG. 4 is a diagram illustrating an example of a satellite information table.

FIG. 5 is a diagram illustrating a configuration example of a portable station (master station).

FIG. 6 is a diagram illustrating a configuration example of a portable station (slave station).

FIG. 7 is a diagram illustrating an example of a process of roughly adjusting the antenna direction.

FIG. 8 is a diagram illustrating an example of a process of finely adjusting the antenna direction.

### DESCRIPTION OF EMBODIMENTS

Hereinafter, an embodiment of an antenna direction adjustment method for a satellite communication system, a portable station, and an antenna direction adjustment program according to the present invention will be described with reference to the drawings.

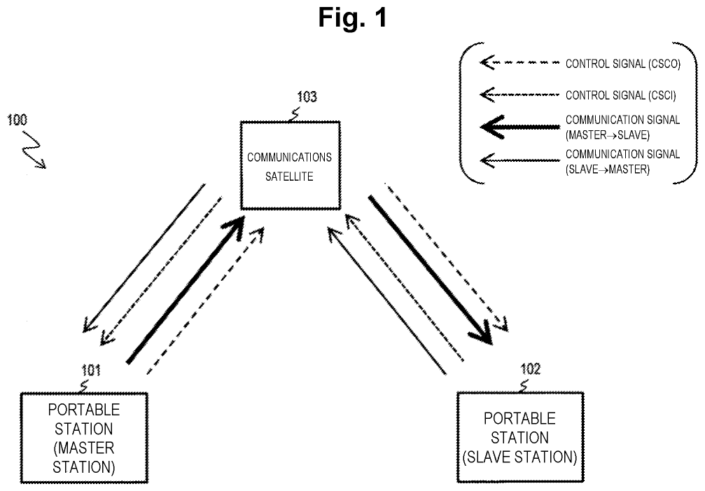

FIG. 1 illustrates an example of a satellite communication system 100 according to the embodiment. The embodiment herein assumes a satellite communication system 100 like the following, for example. The portable station 101 functions as a control station and also as a master station corresponding to a base station of an ordinary VSAT system, while a portable station 102 is a slave station corresponding to a VSAT ground station of an ordinary VSAT system. Additionally, the portable station 101 acting as a master station and the portable station 102 acting as a slave station construct a private network through P-P or P-MP communication, and the satellite communication system 100 is configured without an operation system provided by a control station or the like. For example, in the satellite communication system 100 in FIG. 1, the slave station (portable station 102) communicates with the master station by synchronizing with a control signal transmitted from the master station (portable station 101) through a communications satellite 103. Note that in the case where there is a plurality of slave stations similar to the portable station 102, the slave stations can communicate under control by the master station in a similar way.

In FIG. 1, because the satellite communication system 100 is provided with a plurality of portable ground stations (in FIG. 1, the portable station 101 and the portable station 102) that can be used if in a location where the communications satellite 103 is acquirable, the satellite communication system 100 is effective for securing communication during a disaster or the like. However, in the case where the control signal cannot be exchanged with the base station due to an event such as a large-scale disaster, it is necessary to adjust the antenna direction with respect to the target communications satellite 103 using only a beacon signal when initiating operations.

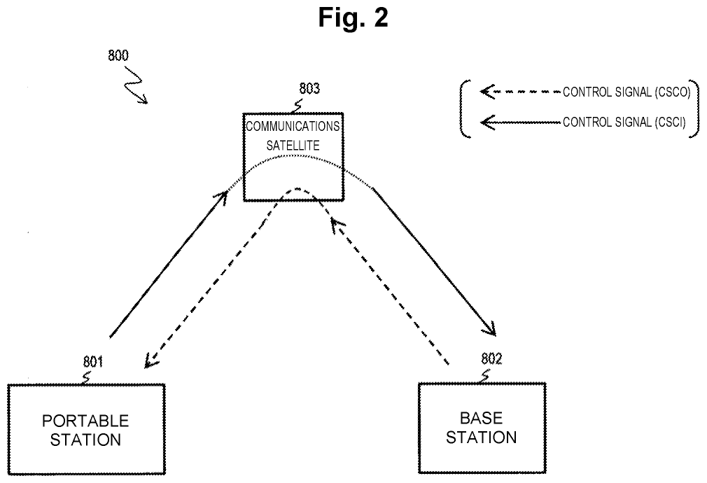

FIG. 2 illustrates an example of an ordinary satellite communication system 800. In FIG. 2, the satellite communication system 800 is provided with a portable station 801, a base station 802, and a communications satellite 803, in which a control signal (CSCO signal) is transmitted continually from the base station 802 and the portable station 801 adjusts the antenna direction using the beacon signal from the communications satellite 803 and then receives the CSCO signal from the base station 802 to establish synchronization with the base station 802, and thereby can perform a final check of the antenna direction with respect to the target communications satellite 803.

In contrast, in the satellite communication system 100 according to the embodiment illustrated in FIG. 1, even in cases where the control signal cannot be exchanged with the base station due to a large-scale disaster or the like, one portable station (in FIG. 1, the portable station 101) from among a plurality of portable stations acts as a master station and performs the operations of a base station and a control station by itself and establishes synchronization by exchanging control signals with the portable station 102 operating as a slave station, thereby making it possible to exchange communication signals between the master station and the slave station.

In FIG. 1, the portable station 101 that operates as a master station in the event of a large-scale disaster or the like receives a beacon signal on a predetermined frequency transmitted from the communications satellite 103 and adjusts the antenna direction while in operation. However, if a plurality of communications satellites have overlapping beacon frequencies, the problem of being unable to specify the communications satellite occurs, and therefore satellite information related to the longitudes and beacon signals of the plurality of communications satellites is stored in advance, the antenna direction with respect to the target communications satellite is calculated on the basis of the longitude of the target communications satellite acquired from the satellite information and the installation location of the portable station itself, and the antenna direction of the portable station itself is adjusted roughly. Thereafter, if the frequency of a measured beacon signal is the frequency of the target communications satellite, the frequencies of beacon signals from a plurality of communications satellites are measured while increasing or decreasing the azimuth, in which the roughly adjusted antenna azimuth is treated as a reference direction. In addition, if the measurement result of a beacon signal from another communications satellite at a longitude corresponding to each azimuth matches information related to the beacon signal from the other communications satellite at the longitude stored in the satellite information, it is determined that the reference direction is the antenna azimuth with respect to the target communications satellite 103. Thereafter, the antenna direction is pointed in the reference direction and adjusted finely so as to maximize the receive level of the received beacon signal. Here, the beacon signal is a continuous wave (CW) signal on a predetermined frequency.

In this way, the satellite communication system 100 according to the embodiment can adjust the antenna direction correctly using only a beacon signal, even in the case where a control signal from a base station is unavailable due to an event such as a large-scale disaster, and even if a plurality of communications satellites have overlapping beacon frequencies. Note that, like the ordinary portable station 801 described in FIG. 2, the portable station 102 that operates as a slave station receives a control signal (CSCO signal) transmitted by the portable station 101 acting as the master station instead of the base station 802 and establishes synchronization with the portable station 101, and thereby can perform a final check of the antenna direction with respect to the target communications satellite 103.

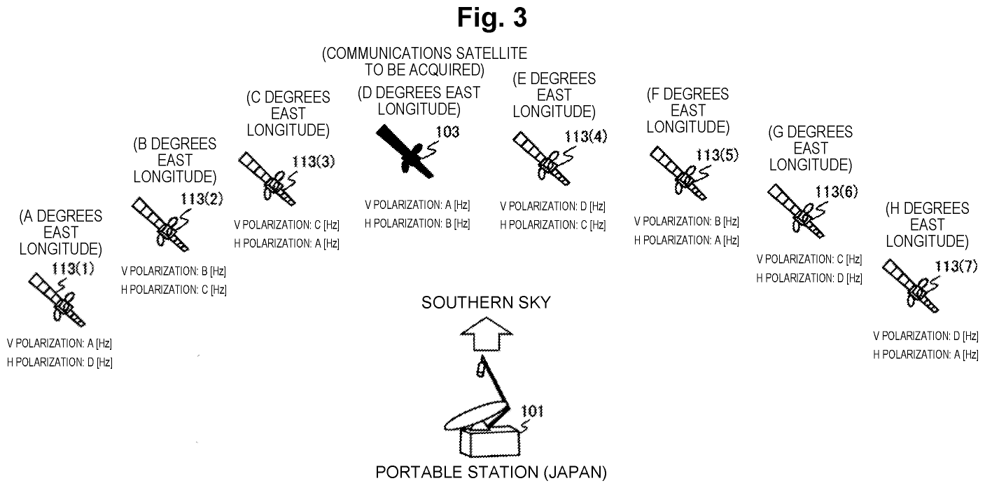

FIG. 3 illustrates an example arrangement of a plurality of communications satellites. In the example of FIG. 3, the portable station 101 is installed on the ground in Japan, and a plurality of eight communications satellites 113(1) to 113(7) including the target communications satellite 103 to be acquired are positioned in the southern sky at different east longitudes. Note that each communications satellite is assumed to be a stationary satellite.

For example, in FIG. 3, the communications satellite 113(1) is in the direction of A degrees east longitude, has a V polarization frequency of A Hz, and has an H polarization frequency of D Hz. Similarly, the communications satellite 113(2) is in the direction of B degrees east longitude, has a V polarization frequency of B Hz, and has an H polarization frequency of C Hz. The communications satellite 113(3) is in the direction of C degrees east longitude, has a V polarization frequency of C Hz, and has an H polarization frequency of A Hz. The target communications satellite 103 to be acquired is in the direction of D degrees east longitude, has a V polarization frequency of A Hz, and has an H polarization frequency of B Hz. The communications satellite 113(4) is in the direction of E degrees east longitude, has a V polarization frequency of D Hz, and has an H polarization frequency of C Hz. The communications satellite 113(5) is in the direction of F degrees east longitude, has a V polarization frequency of B Hz, and has an H polarization frequency of A Hz. The communications satellite 113(6) is in the direction of G degrees east longitude, has a V polarization frequency of C Hz, and has an H polarization frequency of D Hz. The communications satellite 113(7) is in the direction of H degrees east longitude, has a V polarization frequency of D Hz, and has an H polarization frequency of A Hz.

Here, in the case where the target communications satellite of the portable station 101 is the communications satellite 103 at D degrees east longitude, the portable station 101 can determine that the antenna is pointed in the direction of the target communications satellite if the received beacon signal has a V polarization frequency of A Hz and an H polarization frequency of B Hz. However, if there is a plurality of communications satellites with beacon signals on the same frequency, there is a possibility of not recognizing the signal correctly.

Accordingly, in the satellite communication system 100 according to the embodiment, the directions (east longitudes) of a plurality of other communications satellites near the target communications satellite 103 and information about the frequencies of the beacon signals on the V polarization and H polarization are stored in advance as satellite information, the frequencies of each polarization of the beacon signals from the nearby communications satellites 113(1) to 113(7) including the target communications satellite 103 are measured, and by treating the target communications satellite 103 as a reference position to determine whether or not the relative positions of the nearby communications satellites 113 match the satellite information, the target communications satellite 103 is confirmed. With this arrangement, the antenna can be pointed in the direction of the target communications satellite 103 correctly, even if there is a plurality of communications satellites with overlapping frequencies.

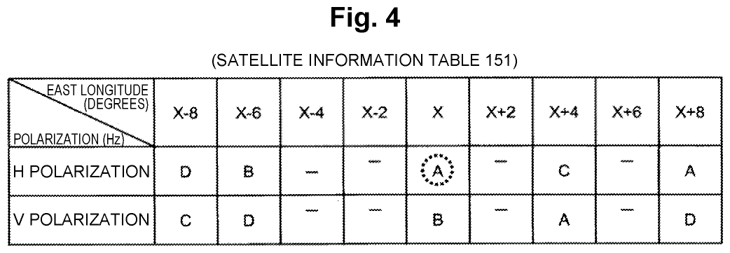

FIG. 4 illustrates an example of a satellite information table 151. Satellite information about the plurality of communications satellites described in FIG. 3 is preregistered in the satellite information table 151. Note that the plurality of communications satellites illustrated in FIG. 3 and the plurality of communications satellites illustrated in FIG. 4 do not necessarily correspond to one another.

In FIG. 4, the east longitude (degrees), the frequency (Hz) of the H polarization of the beacon signal, and the frequency (Hz) of the V polarization of the beacon signal are recorded in the satellite information table 151. Here, the example of FIG. 4 illustrates a table in which the column direction indicates the east longitude, the direction of X degrees east longitude is indicated as the direction of the target communications satellite 103 (reference direction), the four directions of X−2, X−4, X−6, and X−8 decreasing by 2 degrees each are indicated, and the four directions of X+2, X+4, X+6, and X+8 increasing by 2 degrees each are indicated, for a total of nine directions. Also, the row direction indicates the frequency (Hz) of the H polarization and the frequency (Hz) of the V polarization. FIG. 4 illustrates an example of a case in which a communications satellite exists in each of the five directions of (X−8, X−6, X, X+4, X+8) degrees east longitude. For example, in the case where the target communications satellite 103 exists in the direction of X degrees east longitude, it can be understood from the satellite information table 151 that the target communications satellite 103 has an H polarization frequency of A Hz and a V polarization frequency of B Hz.

In this way, the satellite communication system 100 according to the embodiment measures the orbits of the plurality of other communications satellites 113 near the target communications satellite 103 and the V polarization and H polarization beacon signal frequencies of each. Additionally, the satellite communication system 100 according to the embodiment compares the measurement results to the information in the satellite information table 151 to determine whether or not the relative positions of the target communications satellite 103 and the nearby communications satellites 113 are correct, and thereby can confirm the target communications satellite 103 to be acquired.

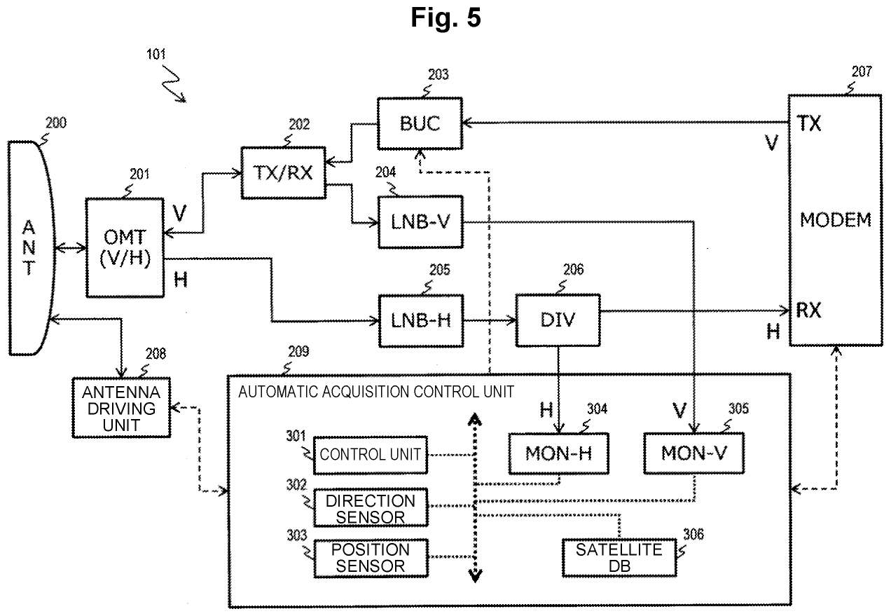

FIG. 5 illustrates a configuration of the portable station 101 (master station). The portable station 101 includes an antenna (ANT) 200, a polarization duplexer (OMT (V/H)) 201, a transmit/receive demultiplexer (TX/RX) 202, a transmitter (BUC) 203, a low-noise amplifier (LNB-V) 204, a low-noise amplifier (LNB-H) 205, a divider (DIV) 206, a modulator-demodulator (MODEM) 207, an antenna driving unit 208, and an automatic acquisition control unit 209. FIG. 5 illustrates an example in which transmit system has the V polarization in the forward direction and the receive system has the H polarization in the forward direction. Note that forward polarization is the polarization in the direction of travel of the radio wave, and in the embodiment, radio waves transmitted from the portable station 101 to the communications satellite 103 have the V polarization in the forward direction, and radio waves transmitted from the communications satellite 103 to the portable station 101 have the H polarization in the forward direction.

The ANT 200 is for example an antenna such as a parabolic antenna that includes an antenna driving mechanism for adjusting the direction under control by the antenna driving unit 208, and transmits and receives wireless radio waves with respect to the communications satellite 103. Note that ANT is an abbreviation of ANTenna.

The OMT (V/H) 201 is a polarization duplexer that splits radio waves into a V-polarized signal and an H-polarized signal, and functions bidirectionally for transmission and reception. For example, a signal received by the ANT 200 is outputted to the TX/RX 202 and the LNB-V 204, while a signal transmitted from the TX/RX 202 is outputted to the ANT 200. Note that OMT is an abbreviation of Ortho Mode Transducer.

The TX/RX 202 is a transmit/receive demultiplexer that splits a signal into a transmit signal and a receive signal.

The BUC 203 is a transmitter combining a high power amplification function with a function of frequency-converting a signal in the 1.2 GHz band outputted by the MODEM 207 to the 14 GHz band, for example. Note that BUC is an abbreviation of Block Up Converter.

The LNB-V 204 is a low-noise amplifier combining a function of amplifying with low noise a V-polarized signal in the 12 GHz band received by the ANT 200 with a function of converting the frequency to the 1.2 GHz band, for example. Note that LNB is an abbreviation of Low Noise Block converter.

The LNB-H 205 is a low-noise amplifier combining a function of amplifying with low noise an H-polarized signal in the 12 GHz band received by the ANT 200 with a function of converting the frequency to the 1.2 GHz band, for example.

The DIV 206 is a divider that divides and outputs an inputted signal into two signals. Note that DIV is an abbreviation of DIVider.

The MODEM 207 is a modulator-demodulator that converts and transmits data signals at a communication rate of 384 kbit/s and also receives and demodulates a modulated signal into a data signal at a communication rate of 1.5 Mbit/s, for example. Note that MODEM is an abbreviation of MOdulator-DEModulator.

The antenna driving unit 208 causes the antenna driving mechanism of the ANT 200 to operate on the basis of commands from the automatic acquisition control unit 209, and thereby adjusts the three directions of the azimuth, the elevation, and the polarization angle. Note that the azimuth is an angle centered on the antenna and turning to the east from true north (corresponding to longitude), the elevation is an angle going upward from the horizontal plane, and the polarization angle is an angle obtained between the horizontal plane and the polarization plane of arriving radio waves.

The automatic acquisition control unit 209 has a computer function that executes a program stored in advance with a control unit 301, and executes processes such as automatic acquisition of the communications satellite 103 and adjustment and checking during operations. For example, the automatic acquisition control unit 209 controls the transmit level of the BUC 203, controls the modulation-demodulation processing by the MODEM 207, controls the antenna driving unit 208, and the like in the portable station 101.

In FIG. 5, the automatic acquisition control unit 209 includes the control unit 301, a direction sensor 302, a position sensor 303, a MON-H 304, a MON-V 305, and a satellite DB 306.

The control unit 301 operates on the basis of a program stored internally in advance, and cooperates with the units of the direction sensor 302, the position sensor 303, the MON-H 304, the MON-V 305, and the satellite DB 306 to adjust the antenna direction with the antenna driving unit 208 and perform a UAT. In addition, the control unit 301 adjusts the transmit level of the BUC 203, controls the MODEM 207 (such as transmitting a continuous wave (CW) and specifying the modulation-demodulation scheme), and the like.

The direction sensor 302 is a sensor that measures the azimuth of the ANT 200. For example, the direction sensor 302 measures the current azimuth of the ANT 200 obtained from the antenna driving unit 208 on the basis of information obtained from an azimuth compass or the like. Here, the azimuth corresponds to longitude.

The position sensor 303 is a sensor that measures the installation location (latitude and longitude) of the portable station 101. A system such as the Global Positioning System (GPS) is used, for example.

The MON-H 304 includes a measuring instrument (such as a spectrum analyzer, for example) capable of measuring the receive level and the frequency, and measures the receive level and the frequency of an H-polarized signal outputted from the DIV 206.

Like the MON-H 304, the MON-V 305 includes a measuring instrument (such as a spectrum analyzer, for example) capable of measuring the receive level and the frequency, and measures the receive level and the frequency of a V-polarized signal outputted from the LNB-V 204. Here, the MON-H 304 and the MON-V 305 correspond to a measurement unit.

The satellite DB 306 is a database including a storage medium such as a hard disk or a memory (corresponding to a storage unit). For example, the satellite information table 151 described in FIG. 4 is included, and information such as position information (such as the east longitude) and beacon signal information (such as the polarization and frequency) of each satellite is stored as satellite information for a plurality of communications satellites including the communications satellite 103.

In the case of adjusting the antenna direction in FIG. 5, the control unit 301 measures the H polarization frequency monitored by the MON-H 304 and the V polarization frequency monitored by the MON-V 305, references the satellite DB 306 to perform rough adjustment treating X degrees east longitude obtained by calculation as a reference direction, and checks whether or not the beacon signal received from the roughly adjusted reference direction is the beacon signal of the target communications satellite. For example, in the case of FIG. 4 described earlier, if the H polarization frequency monitored by the MON-H 304 is A Hz and the V polarization frequency monitored by the MON-V 305 is B Hz in the reference direction, it can be determined that the roughly adjusted reference direction is in the direction of the target communications satellite 103. If the H polarization frequency monitored by the MON-H 304 is C Hz and the V polarization frequency monitored by the MON-V 305 is A Hz in the reference direction, it can be understood from the satellite DB 306 in FIG. 4 that the beacon signal from another communications satellite in the direction of X+4 degrees east longitude is being received. For this reason, by using the antenna driving unit 208 to move the antenna direction by −4 degrees and set a new reference direction, rough adjustment in the direction of the target communications satellite 103 can be performed. Additionally, in the embodiment, the control unit 301 finely adjusts the three directions of the azimuth, the elevation, and the polarization angle of the ANT 200 so as to maximize the receive level in the roughly adjusted reference direction.

In this way, the portable station 101 according to the embodiment can adjust the antenna direction using only a beacon signal and acquire the target communications satellite 103 automatically.

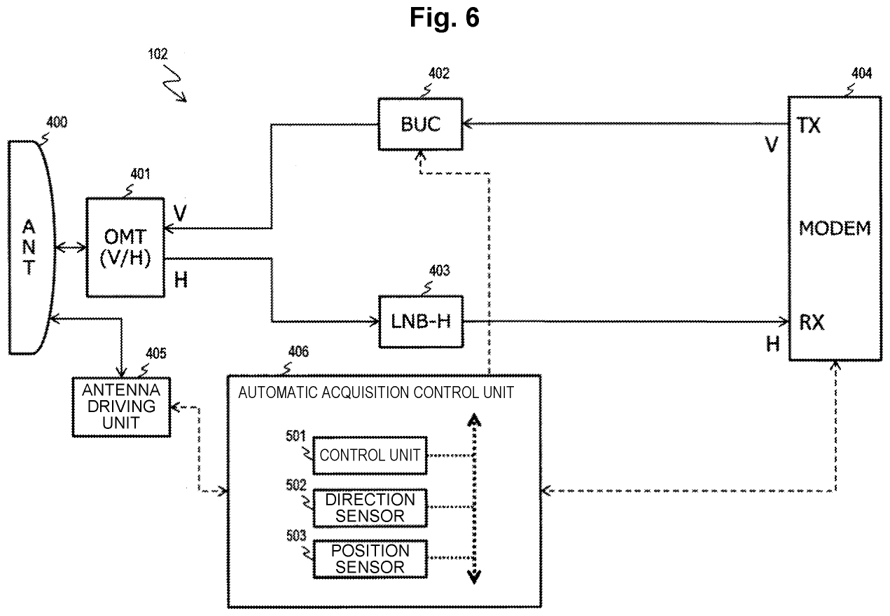

FIG. 6 illustrates a configuration of the portable station 102 (slave station). The portable station 102 acting as a slave station includes an antenna (ANT) 400, a polarization duplexer (OMT (V/H)) 401, a transmitter (BUC) 402, a low-noise amplifier (LNB-H) 403, a modulator-demodulator (MODEM) 404, an antenna driving unit 405, and an automatic acquisition control unit 406. FIG. 6 illustrates an example in which transmit system has the V polarization in the forward direction and the receive system has the H polarization in the forward direction.

Note that the portable station 102 has a configuration similar to the ordinary portable station 801, and communicates a control signal with the base station 802 to establish synchronization and thereby transmit and receive a communication signal. In the case where the base station 802 is nonfunctional, such as during a large-scale disaster, the portable station 102 can communicate a control signal with another portable station (in the embodiment, the portable station 101) that operates as the master station instead of the base station 802 to establish synchronization and thereby transmit and receive a communication signal.

In FIG. 6, the ANT 400, the OMT (V/H) 401, the BUC 402, the LNB-H 403, the MODEM 404, and the antenna driving unit 405 have functions similar to the ANT 200, the OMT (V/H) 201, the BUC 203, the LNB-H 205, the MODEM 207, and the antenna driving unit 208 described in FIG. 5. The automatic acquisition control unit 406 includes a control unit 501, a direction sensor 502, and a position sensor 503. Note that the direction sensor 502 and the position sensor 503 have functions similar to the direction sensor 302 and the position sensor 303 of the automatic acquisition control unit 209 described in FIG. 5.

The control unit 501 calculates the three directions of the azimuth, the elevation, and the polarization angle of the ANT 400 to be adjusted on the basis of the installation location (latitude and longitude) of the ANT 400 acquired from the position sensor 503 and the current direction (longitude) of the ANT 400 acquired from the direction sensor 502, and adjusts the direction of the ANT 400 with the antenna driving unit 405 such that the direction of the ANT 400 points in the direction of the target communications satellite (communications satellite 103) stored in the satellite DB 306. Thereafter, the control unit 501 receives a control signal (CSCO signal) from the portable station 101 acting as the master station through the MODEM 404, and establishes synchronization.

In this way, the portable station 102 acting as a slave station can adjust the antenna direction and establish synchronization with the portable station 101 acting as the master station, and communicate with the portable station 101 or another portable station.

Next, an antenna direction adjustment process by the satellite communication system 100 according to the embodiment will be described.

[Rough Antenna Direction Adjustment Process]

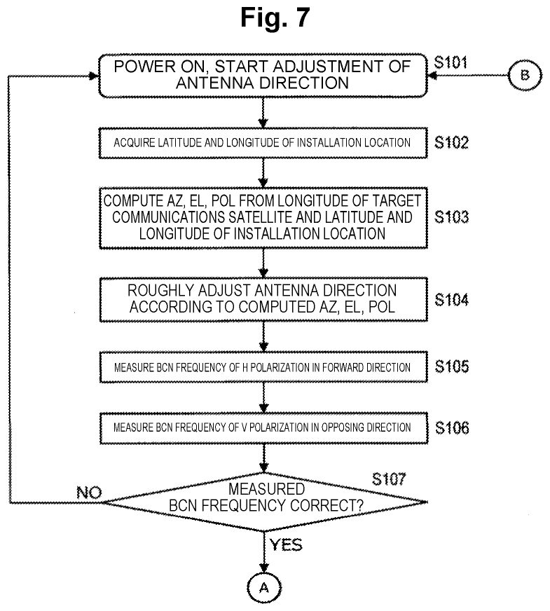

FIG. 7 illustrates an example of a process of roughly adjusting the antenna direction. Note that the process in FIG. 7 is executed by a program stored in advance in the control unit 301 of the automatic acquisition control unit 209 in the portable station 101 illustrated in FIG. 5.

In step S101, the user of the portable station 101 powers on the device and starts adjustment of the antenna direction. Specifically, after power-on, the user uses an operation interface (such as an operation button or operation panel (not illustrated)) of the automatic acquisition control unit 209 in FIG. 5 to instruct the control unit 301 to start adjustment of the antenna direction, and the control unit 301 starts the process of adjusting the antenna direction to acquire the target communications satellite 103.

In step S102, the control unit 301 acquires the latitude and longitude of the installation location. Specifically, in the automatic acquisition control unit 209 in FIG. 5, the control unit 301 measures the latitude and longitude of the installation location of the portable station 101 itself with the position sensor 303.

In step S103, the control unit 301 computes the azimuth, elevation, and polarization angle from the longitude of the target communications satellite 103 and the latitude and longitude of the installation location. Here, the azimuth is denoted AZ (AZimuth), the elevation is denoted EL (ELevation), and the polarization angle is denoted POL (POLarization). Specifically, the control unit 301 computes the direction (AZ, EL, and POL) of the target communications satellite 103 at the installation location of the portable station 101 on the basis of the east longitude of the target communications satellite 103 acquired from the satellite DB 306 and the latitude and longitude of the portable station 101 itself measured in step S102.

In step S104, the control unit 301 roughly adjusts the antenna direction according to the AZ, EL, and POL computed in step S103. Specifically, the control unit 301 uses the antenna driving unit 208 to control the ANT 200 such that the three directions of the AZ direction, the EL direction, and the POL direction respectively match the AZ, EL, and POL computed in step S103. Note that the antenna driving unit 208 includes a three-axis driving device capable of adjusting the three directions of the AZ, EL, and POL independently, for example.

In step S105, the control unit 301 measures the frequency (referred to as the BCN frequency) of the beacon signal having the H polarization in the forward direction. Specifically, the control unit 301 uses the MON-H 304 to measure the frequency of the BCN signal of the H polarization received through the ANT 200, the OMT 201, the LNB-H 205, and the DIV 206.

In step S106, the control unit 301 measures the BCN frequency of the V polarization in the opposing direction. Specifically, the control unit 301 uses the MON-V 305 to measure the frequency of the BCN signal of the V polarization received through the ANT 200, the OMT 201, the TX/RX 202, and the LNB-V 204.

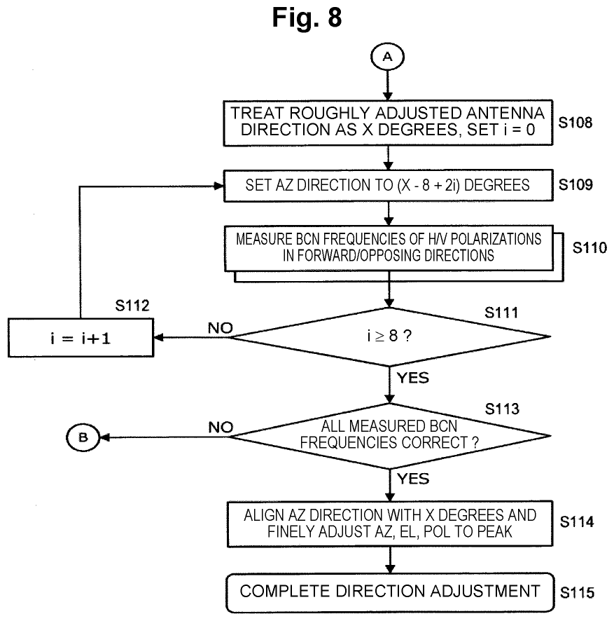

In step S107, the control unit 301 determines whether or not both of the BCN frequencies of the H polarization and the V polarization measured in steps S105 and S106 are correct. If the BCN frequencies are incorrect, the control unit 301 returns to the process of step S101 and executes a similar process, whereas if the BCN frequencies are correct, the control unit 301 executes the fine adjustment process described later (proceeds to the process in (A) of FIG. 8). Specifically, the control unit 301 determines whether or not the measured BCN frequencies of the H polarization and the V polarization match the H polarization frequency and the V polarization frequency of the target communications satellite 103 recorded in the satellite information table 151 of the satellite DB 306 described in FIG. 4.

In this way, the satellite communication system 100 according to the embodiment can roughly adjust the antenna direction in the direction of the target communications satellite 103.

[Fine Antenna Direction Adjustment Process]

FIG. 8 illustrates an example of a process of finely adjusting the antenna direction. Note that the process in FIG. 8 is executed by a program stored in advance in the control unit 301 of the automatic acquisition control unit 209 in the portable station 101 illustrated in FIG. 5. Here, (A) and (B) illustrated in FIG. 8 are connected to (A) and (B) of the same name illustrated in FIG. 7, respectively. For example, in the case of a YES determination in the process of step S107 in FIG. 7, the flow proceeds to the process of step S108 in FIG. 8. Similarly, in the case of a NO determination in the process of step S114 in FIG. 8, the flow proceeds to the process of step S101 in FIG. 7.

In step S108, the control unit 301 treats the antenna direction roughly adjusted by the process in FIG. 7 as X degrees (the reference direction) described using FIGS. 3 and 4, and initializes a counter i by setting i=0.

In step S109, the control unit 301 initializes the AZ direction to (X−8+2i) degrees. Specifically, for example, when i=0, in the satellite information table 151 in FIG. 4, the AZ direction is set to (X−8) degrees east longitude and incremented by two degrees every time the counter i is incremented by 1, such that the AZ direction of the antenna changes to (X−6) degrees east longitude, (X−4) degrees east longitude, (X−2) degrees east longitude, (X) degrees east longitude, (X+2) degrees east longitude, (X+4) degrees east longitude, (X+6) degrees east longitude, and (X+8) degrees east longitude.

In step S110, the control unit 301 respectively measures the BCN frequency of the H polarization or the V polarization corresponding to the forward direction or the opposing direction. Specifically, the control unit 301 uses the MON-H 304 to measure the frequency of the BCN signal of the H polarization similarly to step S105 in FIG. 7, and uses the MON-V 305 to measure the frequency of the BCN signal of the V polarization similarly to step S106 in FIG. 7. Note that the control unit 301 performs the measurement for each value of the counter i (for each east longitude), and saves the measurement results for each east longitude.

In step S111, the control unit 301 determines whether or not the counter i is 8 or greater (i≥8). If i≥8, the control unit 301 proceeds to the process of step S113, whereas if i<8, the control unit 301 proceeds to the process of step S112. Here, the embodiment describes an example of targeting the range from (X−8) degrees east longitude to (X+8) degrees east longitude in the satellite information table 151 illustrated in FIG. 4, but a range from (X−10) degrees east longitude to (X+10) degrees east longitude or a range from (X−6) degrees east longitude to (X+6) degrees east longitude may also be targeted, for example. Moreover, the east longitude does not have to be increased or decreased by two degrees at a time, and the angle ranges in the positive and negative directions may also be asymmetric.

In step S112, the control unit 301 increments the counter i by one (i=i+1) and returns to the process of step S109. With this arrangement, in step S109, the antenna direction is set to the direction increased by 2 degrees east longitude.

In step S113, the control unit 301 determines whether or not the measurement results of the BCN frequency of the H polarization and the BCN frequency of the V polarization for each east longitude saved in step S110 are correct. Specifically, the control unit 301 compares the measurements of the orbits of the plurality of other communications satellites 113 orbiting nearby, including the target communications satellite 103, and the frequencies of the beacon signal of the V polarization and the H polarization of each to the information in the satellite information table 151, and determines whether or not the relative positions of the target communications satellite 103 and the nearby communications satellites 113 are correct. Thereafter, in the case of determining that the relative positions are correct, the reference direction is in the direction of the target communications satellite 103 and therefore the control unit 301 proceeds to the process of step S114, whereas in the case of determining that the relative positions are incorrect, the reference direction is not in the direction of the target communications satellite 103 and therefore the control unit 301 proceeds to (B) of FIG. 7 corresponding to (B) of FIG. 8, and returns to step S101 of the rough adjustment process. Thereafter, the rough adjustment process is executed again.

In step S114, the control unit 301 aligns the AZ direction with X degrees east longitude of the reference direction and finely adjusts the AZ direction, the EL direction, and the POL direction. Specifically, the control unit 301 uses the MON-H 304 to measure the receive level of the BCN signal of the H polarization and uses the MON-V 305 to measure the receive level of the BCN signal of the V polarization while controlling the antenna driving unit 208 to move the ANT 200 back and forth slightly and make fine adjustments in each of the AZ direction, the EL direction, and the POL direction such that the receive level reaches a peak (maximum).

In step S115, the control unit 301 completes the adjustment of the antenna direction.

In this way, by making fine adjustments after roughly adjusting the antenna direction, the satellite communication system 100 according to the embodiment can point the antenna in the direction of the target communications satellite 103. In particular, because the satellite communication system 100 according to the embodiment determines whether or not the relative position of the target communications satellite 103 with respect to other nearby communications satellites is correct, it is possible to acquire the target communications satellite 103 using a beacon signal only and adjust the antenna direction in the direction of the communications satellite 103, even in the case where the other communications satellites have overlapping BCN frequencies.

Here, a program corresponding to the processes described in FIGS. 7 and 8 may also be executed by a computer. In addition, the program may be provided by being recorded onto a storage medium or may be provided over a network.

As described in the embodiment above, for antenna direction adjustment based on a beacon signal, the antenna direction adjustment method for a satellite communication system, the portable station, and the antenna direction adjustment program according to the present invention are capable of adjusting the antenna direction correctly using only a beacon signal, even in the case where a control signal from a base station is unavailable due to an event such as a large-scale disaster.

Note that although one embodiment of the present invention has been described in detail, the present invention is not limited thereto. For example, the above embodiment describes an aspect in which a plurality of portable stations communicate via a communications satellite, but depending on the usage scenario, the medium of communication may also be equipment other than a communications satellite, such as a radio-controlled helicopter (drone) or an unmanned aerial vehicle in a high-altitude platform.

### REFERENCE SIGNS LIST

100 satellite communication system
101 portable station (master station)
102 portable station (slave station)
103 communications satellite
151 satellite information table
200, 400 ANT
201, 401 OMT
202 TX/RX
203, 402 BUC
204 LNB-V
205, 403 LNB-H
206 DIV
207, 404 MODEM
208, 405 antenna driving unit
209, 406 automatic acquisition control unit
301, 501 control unit
302, 502 direction sensor
303, 503 position sensor
304 MON-H
305 MON-V
306 satellite DB
800 satellite communication system
801 portable station
802 base station
803 communications satellite

1. An antenna direction adjustment method for a satellite communication system provided with a portable station, wherein the portable station
stores satellite information related to a longitude and a beacon signal of a plurality of communications satellites,
executes a rough adjustment process of computing an antenna direction with respect to a target communications satellite on a basis of the longitude of the target communications satellite acquired from the satellite information and an installation location of the portable station itself, and roughly adjusting the antenna direction of the portable station itself in the computed antenna direction, and
executes a fine adjustment process of, in a case where a frequency of a beacon signal received from a satellite is a predetermined frequency of the target communications satellite, measuring the beacon signal while increasing or decreasing the azimuth by treating the azimuth of the roughly adjusted antenna as a reference direction, and in a case where a measurement result of a beacon signal from another communications satellite at a longitude corresponding to each azimuth matches the information related to the beacon signal from the other communications satellite at the longitude that is stored in the satellite information, aligning the azimuth of the antenna with the reference direction and finely adjusting the antenna direction such that a receive level of the received beacon signal is maximized.

2. The antenna direction adjustment method according to claim 1, wherein
the information related to the beacon signal is a frequency of polarization in a forward direction and a frequency of polarization in an opposing direction of the beacon signal,
the antenna direction, the rough adjustment, and the fine adjustment computed in the rough adjustment process and the fine adjustment process are an azimuth, an elevation, and a polarization angle of the antenna with respect to the target communications satellite, and in the fine adjustment process, in a case where the polarization and the frequency of the beacon signal from another communications satellite at a longitude corresponding to each azimuth matches the polarization and the frequency of the beacon signal from the other communications satellite at the longitude stored in the satellite information, the azimuth of the antenna is aligned with the reference direction and each of the azimuth, the elevation, and the polarization angle is finely adjusted such that the receive level of the received beacon signal is maximized.

3. A portable station used in a satellite communication system, the portable station comprising:
a storage unit that stores satellite information related to a longitude and a beacon signal of a plurality of communications satellites;
a processor; and
a storage medium having computer program instructions stored thereon, when executed by the processor, perform to:
receives a beacon signal from a communications satellite and measures a frequency at each polarization; and
executes a rough adjustment process of computing an antenna direction with respect to a target communications satellite on a basis of the longitude of the target communications satellite acquired from the satellite information and an installation location of the portable station itself, and controlling an antenna direction driving unit to roughly adjust the antenna direction of the portable station itself in the computed antenna direction, and executes a fine adjustment process of, in a case where a frequency for each polarization of a beacon signal measured by the measurement unit is a predetermined frequency of the target communications satellite, performing the measurement while increasing or decreasing the azimuth by treating the azimuth of the roughly adjusted antenna as a reference direction, and in a case where a measurement result of a beacon signal from another communications satellite at a longitude corresponding to each azimuth matches the information related to the beacon signal from the other communications satellite at the longitude that is stored in the satellite information, aligning the azimuth of the antenna with the reference direction and finely adjusting the antenna direction such that a receive level of the received beacon signal is maximized.

4. The portable station according to claim 3, wherein the information related to the beacon signal is a frequency of polarization in a forward direction and a frequency of polarization in an opposing direction of the beacon signal,
the antenna direction, the rough adjustment, and the fine adjustment computed in the rough adjustment process and the fine adjustment process are an azimuth, an elevation, and a polarization angle of the antenna with respect to the target communications satellite, and in the fine adjustment process, in a case where the polarization and the frequency of the beacon signal from another communications satellite at a longitude corresponding to each azimuth matches the polarization and the frequency of the beacon signal from the other communications satellite at the longitude stored in the satellite information, the azimuth of the antenna is aligned with the reference direction and each of the azimuth, the elevation, and the polarization angle is finely adjusted such that the receive level of the received beacon signal is maximized.

5. An antenna direction adjustment program that causes a computer to execute the process performed according to the antenna direction adjustment method according to claim 1.
